(19) United States
(12) Patent Application Publication
(10) Pub. No.: US 2026/0072168 A1
(43) Pub. Date: Mar. 12, 2026

(54) OPTICAL NAVIGATION DEVICE WITH ACCURATE SPEED DETECTING FUNCTION

(71) Applicant: PixArt Imaging Inc., Hsin-chu City (TW)

(72) Inventor: Yen-Hung Wang, Hsin-chu City (TW)

(73) Assignee: PixArt Imaging Inc., Hsin-chu City (TW)

(21) Appl. No.: 19/051,213

(22) Filed: Feb. 12, 2025

Related U.S. Application Data
(60) Provisional application No. 63/693,205, filed on Sep. 11, 2024.

(51) Int. Cl. G01S 17/58; G01S 7/481; G01S 17/88

(52) U.S. Cl. CPC G01S 17/58; G01S 7/4811; G01S 7/4814; G01S 7/4816; G01S 17/88

(57) ABSTRACT

An optical navigation device is used to detect a relatively moving speed between the optical navigation device and a target object. The optical navigation device includes an optical element assembly, an optical detector and an illumination light source. The optical detector is disposed adjacent to the optical element assembly, and adapted to acquire a detection image of the target object through the optical element assembly. The illumination light source is disposed next to the optical element assembly in a manner that does not affect magnification of an imaging result produced by reflection from the target object through the optical element assembly.

### CROSS REFERENCE TO RELATED APPLICATIONS

This application claims the benefit of U.S. Provisional Application No. 63/693,205, filed on Sep. 11, 2024. The content of the application is incorporated herein by reference.

### BACKGROUND OF THE INVENTION

### 1. Field of the Invention

The present invention relates to an optical navigation device, and more particularly, to an optical navigation device of accurately detecting a relatively moving speed between the optical navigation device and a target object.

### 2. Description of the Prior Art

A conventional optical navigation device has an illumination light source disposed near the optical element assembly and the optical detector; the illumination light emits illumination light towards a target object, and the optical detector receives the illumination light reflected from the target object and passing through the optical element assembly to generate a detection image. In the conventional optical navigation device, the illumination light source is placed in the case and close to the optical detector, which means that a distance between the target object and a light emitting surface of the illumination light source is much greater than a distance between the target object and a focus plane of the optical navigation device. During the navigation process, when an interval of the optical navigation device relative to the target object is varied due to environment change, the conventional optical navigation device can determine a relatively moving direction between the optical navigation device and the target object, but cannot accurately compute a relatively moving speed between the optical navigation device and the target object; the foresaid drawback limits the applicable field of the conventional optical navigation device. Therefore, design of an optical navigation device of accurately determining the moving direction and the moving speed relative to the target object is an important issue in the related optical navigation industry.

### SUMMARY OF THE INVENTION

The present invention provides an optical navigation device of accurately detecting a relatively moving speed between the optical navigation device and a target object for solving above drawbacks.

According to the claimed invention, an optical navigation device is used to detect a relatively moving speed between the optical navigation device and a target object. The optical navigation device includes an optical element assembly, an optical detector and an illumination light source. The optical detector is disposed adjacent to the optical element assembly, and adapted to acquire a detection image of the target object through the optical element assembly. The illumination light source is disposed next to the optical element assembly in a manner that does not affect magnification of an imaging result produced by reflection from the target object through the optical element assembly.

According to the claimed invention, the magnification is a ratio of an image distance between the optical element assembly and the optical detector to an object distance between the optical element assembly and a focus plane of the optical navigation device, and a light emitting surface of the illumination light source aligns with the focus plane. A distance of the focus plane relative to the target object is equal to a distance of the light emitting surface relative to the target object.

According to the claimed invention, the optical navigation device further includes a collimating lens disposed adjacent to a light emitting surface of the illumination light source for generating and projecting a collimated beam onto the target object. The optical navigation device further includes an operation processor electrically connected with the optical detector, the operation processor is adapted to analyze the detection image and compute the relatively moving speed in accordance with a frame rate of the optical detector and the magnification, so that sampling resolution of the optical navigation device is constant when a relative distance between the optical navigation device and the target object is changed. The optical element assembly includes a convergence lens.

According to the claimed invention, the manner that does not affect the magnification of the imaging result produced by the reflection from the target object through the optical element assembly is interpreted as: a speckle moving speed detected by the optical detector is equal to a product of the relatively moving speed and the magnification, or is twice the foresaid product. The optical navigation device is adapted to apply the optical element assembly with high magnification for the optical detector and the illumination light source in response to the optical detector having a low frame rate or a small detection surface.

According to the claimed invention, a detection surface of the optical detector has a specific section with a maximal length than other sections, and a longitudinal direction of the specific section is parallel to a moving direction between the optical navigation device and the target object. The optical detector and the illumination light source are respectively disposed on two opposite sides of the optical element assembly; or, the optical element assembly and the illumination light source are respectively disposed on two opposite sides of the optical detector.

According to the claimed invention, a specific included angle is formed between an optical detection axis of the optical detector and an optical illumination axis of the illumination light source. The optical navigation device further includes a beam splitter, and the optical detector and the illumination light source are disposed respectively corresponding to two opposite optical surfaces of the beam splitter.

The optical navigation device of the present invention can align the light emitting surface of the illumination light source with the focus plane of the optical element assembly, so that the speckle moving speed detected by the optical detector can be twice the product of the relatively moving speed between the optical navigation device and the target object and the magnification of the optical element assembly; or, the optical navigation device of the present invention can have the collimating lens disposed on position in front of the light emitting surface of the illumination light source to form the collimated beam, and the speckle moving speed detected by the optical detector can be equal to the product of the relatively moving speed between the optical navigation device and the target object and the magnification of the optical element assembly. The optical navigation device may include the optical detector having a low frame rate or a small detection surface, and the present invention can accordingly apply the optical element assembly with high magnification for the optical detector and the illumination light source; in this way, even if the moving speed of the target object is fast, the speckle moving speed detected by the optical detector can be reduced by the optical element assembly with the high magnification, so as to further increase the ultimate speed of the target object that the optical navigation device can detect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an optical navigation device according to an embodiment of the present invention.

FIG. 2 is a side view diagram of the optical navigation device according to the embodiment of the present invention.

FIG. 3 is an architecture diagram of the optical navigation device according to the embodiment of the present invention.

FIG. 4 is an arrangement diagram of an optical detector according to the embodiment of the present invention.

FIG. 5 is a side view diagram of the optical navigation device according to another embodiment of the present invention.

FIG. 6 is a side view diagram of the optical navigation device according to another embodiment of the present invention.

### DETAILED DESCRIPTION

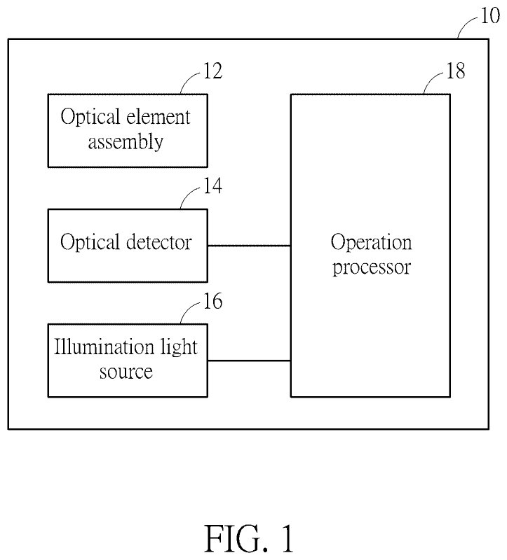

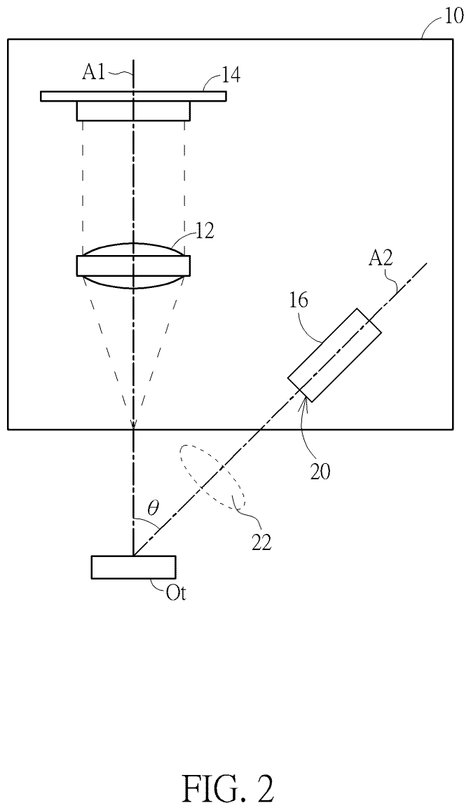

Please refer to FIG. 1 and FIG. 2. FIG. 1 is a functional block diagram of an optical navigation device 10 according to an embodiment of the present invention. FIG. 2 is a side view diagram of the optical navigation device 10 according to the embodiment of the present invention. The optical navigation device 10 can detect a relative distance and a relatively moving speed between the optical navigation device 10 and a target object Ot, and can further automatically calibrate variation of sampling resolution (or DPI, Dots Per Inch) generated by change of the relative distance, so as to keep the sampling resolution in constant for accurately computing the relatively moving speed. The optical navigation device 10 may be applied for a vehicle, a mouse, a robot vacuum, or any electronic product with a function of detecting the relative distance and the relatively moving speed. For example, the optical navigation device 10 can be installed on the vehicle chassis, and the optical navigation device 10 can still identify and analyze identification points (which means the target object Ot) on the ground to accurately compute the direction and the speed of the vehicle even through the vehicle moves on an uneven ground.

The optical navigation device 10 can include an optical element assembly 12, an optical detector 14, an illumination light source 16 and an operation processor 18. The optical element assembly 12 can have optical elements such as a convergence lens; a number, a type and arrangement of the optical elements can depend on a design demand, and a detailed description is omitted herein for simplicity. The optical detector 14 and the illumination light source 16 can be disposed on position near the optical element assembly 12. The illumination light source 16 can emit illumination light to project onto the target object Ot. The optical detector 14 can receive the illumination light reflected from the target object Ot and passing through the optical element assembly 12 for acquiring a detection image of the target object Ot.

The operation processor 18 can be electrically connected with the optical detector 14 and the illumination light source 16. The operation processor 18 can actuate or shut down the illumination light source 16, and analyze the detection image in accordance with a frame rate of the optical detector 14 and magnification of the optical element assembly 12 for computing the relatively moving speed. It should be mentioned that the illumination light source 16 can be disposed next to the optical element assembly 12 in a manner that does not affect the magnification of an imaging result produced by reflection from the target object Ot through the optical element assembly 12; when the relative distance between the optical navigation device 10 and the target object Ot is changed, the sampling resolution of the optical navigation device 10 can be constant, and therefore the relatively moving speed between the optical navigation device 10 and the target object Ot can be accurately computed.

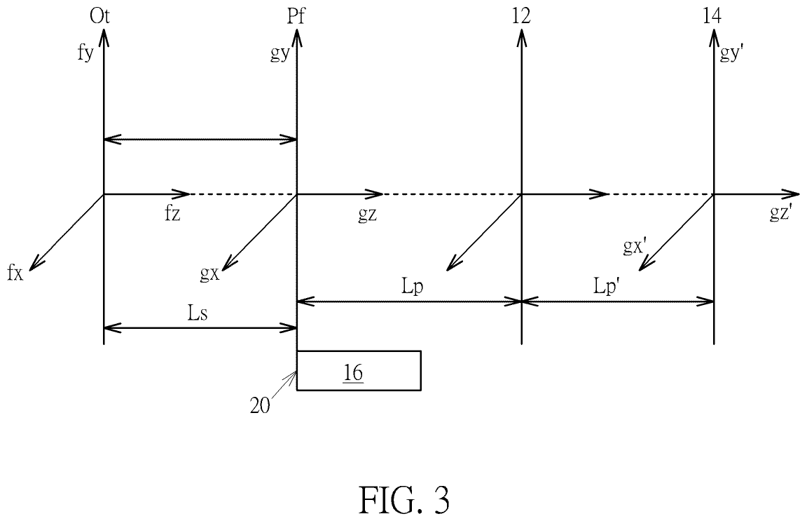

Please refer to FIG. 3. FIG. 3 is an architecture diagram of the optical navigation device 10 according to the embodiment of the present invention. In FIG. 3, symbols fx, fy and fz can be defined as axes of a three-dimensional coordinate system where on the target object Ot is located;, symbols gx, gy and gz can be defined as axes of the three-dimensional coordinate system where on a focal plane Pf of the optical navigation device 10 is located; symbols gx′, gy′ and gz′ can be defined as axis of the three-dimensional coordinate system where on the optical detector 14 is located. The optical element assembly 12 can be preferably located between the target object Ot and the optical detector 14, and axes of the optical element assembly 12 can preferably align with the foresaid axes of the optical detector 14, the focus plane Pf and the target object Ot. The magnification mentioned in the embodiment can be interpreted as: a ratio of an image distance Lp′ between the optical element assembly 12 and the optical detector 14 to an object distance Lp between the optical element assembly 12 and the focus plane Pf of the optical navigation device 10; besides, a light emitting surface 20 of the illumination light source 16 can preferably align with the focus plane Pf.

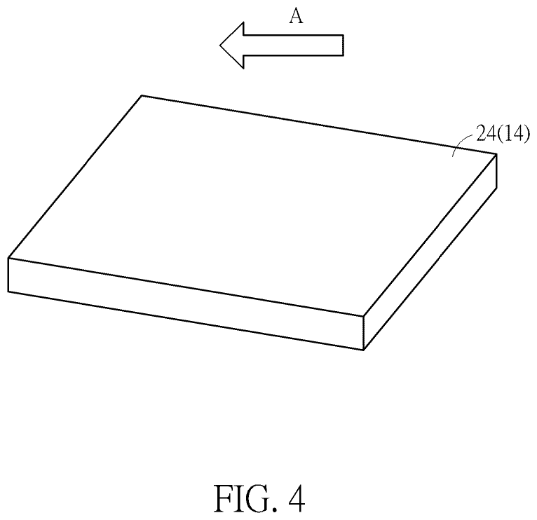

In formula 1, a symbol Ax′ can be defined as a speckle moving speed of the identification point moved on a detection surface 24 (which is marked in FIG. 4) of the optical detector 14; a symbol m can be defined as the foresaid magnification; a symbol ax can be defined as a movement datum of the target object Ot in the real world; a symbol Lo′ can be defined as a distance of the focus plane Pf relative to the target object Ot; a symbol Ls can be defined as a distance of the light emitting surface 20 of the illumination light source 16 relative to the target object Ot. Moreover, symbols Isx and Ix can be respectively defined as movement data of the illumination light source 16 and an optical system (such as the optical element assembly 12 and the optical detector 14 of the optical navigation device 10). In the preferred embodiment of the optical navigation device 10, the present invention can set that the distance Lo′ of the focus plane Pf relative to the target object Ot is the same as the distance Ls of the light emitting surface 20 relative to the target object Ot; when the optical navigation device 10 is installed on the vehicle chassis, the sampling resolution of the optical navigation device 10 can still be maintained at a changed value and not affected by change in the relative distance, even if the rugged ground causes change of the relative distance between the optical navigation device 10 and the target object Ot.

$$\frac{{Ax}^{′}}{m} = - ax [ \frac{{Lo}^{′}}{Ls} ( {Isx}^{2} - 1 ) + {IX}^{2} - 1 ] \qquad Formula 1$$

Besides, in another possible embodiment of the present invention, the light emitting surface 20 of the illumination light source 16 is not limited to set at position aligning with the focus plane Pf; the optical navigation device 10 may optionally set a collimating lens 22 in front of the light emitting surface 20 of the illumination light source 16, so as to form a collimated beam projected onto the target object Ot. In the said embodiment, the distance Ls of the light emitting surface 20 relative to the target object Ot becomes infinite; based on formula 1, when the relative distance between the optical navigation device 10 and the target object Ot is changed, the sampling resolution of the optical navigation device 10 can be constant and not affected by change in the relative distance.

In the present invention, the illumination light source 16 can be disposed near the optical element assembly 12 in the manner that does not affect the magnification of the imaging result produced by reflection from the target object Ot through the optical element assembly 12, and therefore the speckle moving speed Ax′ detected by the optical detector 14 can be the same as a product of the relatively moving speed (such as the symbol ax) between the optical navigation device 10 and the target object Ot and the magnification m of the optical element assembly 12 (which corresponds to the embodiment that the collimating lens 22 is disposed in front of the light emitting surface 20 of the illumination light source 16 to form the collimated beam), or the speckle moving speed Ax′ can be twice the foresaid product (which corresponds to the embodiment that the light emitting surface 20 of the illumination light source 16 aligns with the focus plane Pf). Regardless of whether the distance Ls is designed to be the same as the distance Lo′ or infinite, a ratio of a detection moving distance (which corresponds to the symbol Ax′) of the imaging result on the optical detector 14 to an actual moving distance (which corresponds to the symbol ax) of the target object Ot in the real world can be limited to a preset value, which means the foresaid ratio (or the preset value) can be the same as the magnification (such as the symbol m) or the same as twice the magnification, and the sampling resolution of the optical navigation device 10 is not varied due to change in the relative distance.

In one possible embodiment of the present invention, the vehicle travels at high speed, and the optical navigation device 10 can be installed on the vehicle chassis to compute the accurate speed of the vehicle. Please refer to FIG. 4. FIG. 4 is an arrangement diagram of the optical detector 14 according to the embodiment of the present invention. An arrow A shown in FIG. 4 can indicate a relatively moving direction between the optical navigation device 10 and the target object Ot, and only a simple outline of the optical detector 14 is drawn to illustrate the relevant features. Generally, the detection surface 24 of the optical detector 14 can be a square, and four sides of the square have the same length; a diagonal length of the square can be greater than a side length of the square, so the diagonal can be defined as a specific section with a maximal length than lengths of other sections (such as the side length). The present invention can preferably install the optical navigation device 10 on the vehicle chassis by a longitudinal direction of the diagonal (which means the specific section) being parallel to the relatively moving direction A between the optical navigation device 10 and the target object Ot, so as to increase an allowable detection speed of the optical navigation device 10, and therefore the optical navigation device 10 can provide preferred detection accuracy when applying for the high speed vehicle.

In other possible embodiment of the present invention, the detection surface 24 of the optical detector 14 may be an oval, and the optical navigation device 10 can be installed on the vehicle chassis by the longitudinal direction of a long axis of the oval (which can be interpreted as the specific section) of the optical detector 14 being parallel to the relatively moving direction A. Further, the detection surface 24 of the optical detector 14 may be a rectangle, and the optical navigation device 10 can be installed on the vehicle chassis by the longitudinal direction of a long side of the rectangle (which can be interpreted as the specific section) of the optical detector 14 being parallel to the relatively moving direction A. The shape of the detection surface 24 is not limited to the foresaid embodiment. Any optical navigation device 10 having the optical detector 14 that is arranged by pointing the longitudinal direction of a longest section of the detection surface 24 parallel to the moving direction A can conform to a design scope of the present invention.

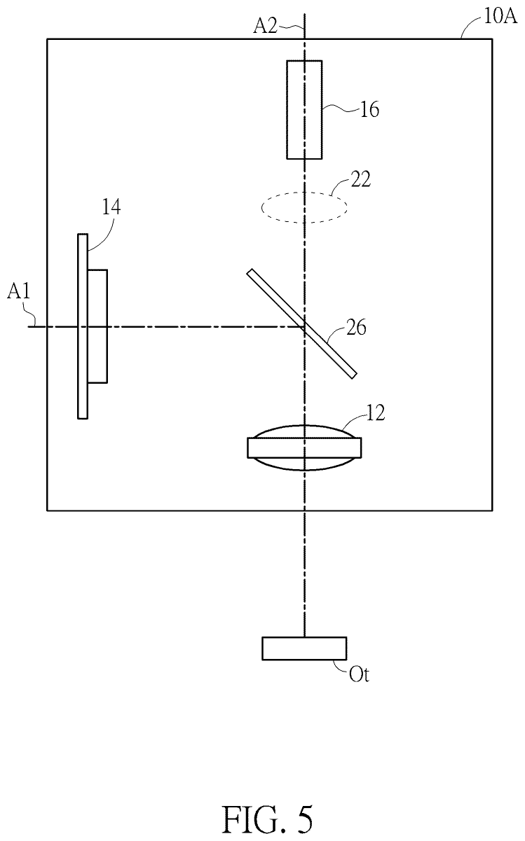

Please refer to FIG. 2 and FIG. 5. FIG. 5 is a side view diagram of the optical navigation device 10A according to another embodiment of the present invention. In this embodiment, elements having the same numerals as ones of the embodiment shown in FIG. 2 can have the same functions, and the detailed description is omitted herein for simplicity. The embodiment shown in FIG. 2 can set a specific included angle θ formed between an optical detection axis A1 of the optical detector 14 and an optical illumination axis A2 of the illumination light source 16, which means optical element configuration of the optical navigation device 10 can be a tilted architecture. In addition, the embodiment shown in FIG. 5 can set a beam splitter 26 with a semi-transmissive and semi-reflective property next to the optical element assembly 12 of the optical navigation device 10A; the optical detector 14 and the illumination light source 16 can be respectively disposed on positions corresponding to two opposite optical surfaces of the beam splitter 26, and the collimating lens 22 can be preferably disposed in front of the illumination light source 16. As shown in FIG. 5, the illumination light emitted by the illumination light source 16 can pass through the beam splitter 26 to project onto the target object Ot, and the optical detector 14 can receive reflection light generated from the target object Ot and reflected by the beam splitter 26 to generate the detection image of the target object Ot. The beam splitter 26 may utilize polarization difference or wavelength difference between the light illumination light and the reflection light to provide the semi-transmissive and semi-reflective property; therefore, optical element configuration of the optical navigation device 10A can be a coaxial architecture.

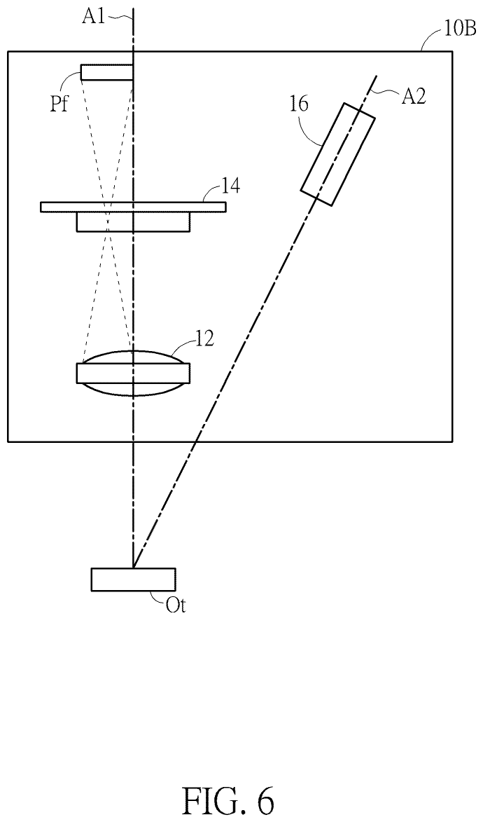

Please refer to FIG. 6. FIG. 6 is a side view diagram of the optical navigation device 10B according to another embodiment of the present invention. In this embodiment, elements having the same numerals as ones of the foresaid embodiment can have the same functions, and the detailed description is omitted herein for simplicity. The embodiment shown in FIG. 2 can dispose the optical detector 14 and the illumination light source 16 respectively on two opposite sides of the optical element assembly 12, and the target object Ot can form a real image on the detection surface 24 of the optical detector 14. In addition, the embodiment shown in FIG. 6 can dispose the optical element assembly 12 and the illumination light source 16 of the optical navigation device 10B respectively on two opposite sides of the optical detector 14, and the target object Ot can form a virtual image (which is on position where on the focus plane Pf is located) behind the detection surface 24 of the optical detector 14. The optical element assembly 12, the optical detector 14 and the illumination light source 16 of the optical navigation device 10 can have various placement positions, and is not limited to the foresaid embodiment.

In conclusion, the optical navigation device of the present invention can align the light emitting surface of the illumination light source with the focus plane of the optical element assembly, so that the speckle moving speed detected by the optical detector can be twice the product of the relatively moving speed between the optical navigation device and the target object and the magnification of the optical element assembly; or, the optical navigation device of the present invention can have the collimating lens disposed on position in front of the light emitting surface of the illumination light source to form the collimated beam, and the speckle moving speed detected by the optical detector can be equal to the product of the relatively moving speed between the optical navigation device and the target object and the magnification of the optical element assembly. The optical navigation device may include the optical detector having a low frame rate or a small detection surface, and the present invention can accordingly apply the optical element assembly with high magnification for the optical detector and the illumination light source; in this way, even if the moving speed of the target object is fast, the speckle moving speed detected by the optical detector can be reduced by the optical element assembly with the high magnification, so as to further increase the ultimate speed of the target object that the optical navigation device can detect.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical navigation device of detecting a relatively moving speed between the optical navigation device and a target object, the optical navigation device comprising:
an optical element assembly;
an optical detector disposed adjacent to the optical element assembly, and adapted to acquire a detection image of the target object through the optical element assembly; and
an illumination light source disposed next to the optical element assembly in a manner that does not affect magnification of an imaging result produced by reflection from the target object through the optical element assembly;
wherein a ratio of a moving distance of the imaging result to a moving distance of the target object is limited to a preset value.

2. The optical navigation device of claim 1, wherein the magnification is a ratio of an image distance between the optical element assembly and the optical detector to an object distance between the optical element assembly and a focus plane of the optical navigation device, and a light emitting surface of the illumination light source aligns with the focus plane.

3. The optical navigation device of claim 2, wherein a distance of the focus plane relative to the target object is equal to a distance of the light emitting surface relative to the target object.

4. The optical navigation device of claim 1, wherein the optical navigation device further comprises a collimating lens disposed adjacent to a light emitting surface of the illumination light source for generating and projecting a collimated beam onto the target object.

5. The optical navigation device of claim 1, wherein the optical navigation device further comprises an operation processor electrically connected with the optical detector, the operation processor is adapted to analyze the detection image and compute the relatively moving speed in accordance with a frame rate of the optical detector and the magnification, so that sampling resolution of the optical navigation device is constant when a relative distance between the optical navigation device and the target object is changed.

6. The optical navigation device of claim 1, wherein the manner that does not affect the magnification of the imaging result produced by the reflection from the target object through the optical element assembly is interpreted as: a speckle moving speed detected by the optical detector is equal to a product of the relatively moving speed and the magnification, or is twice the foresaid product.

7. The optical navigation device of claim 1, wherein the optical navigation device is adapted to apply the optical element assembly with high magnification for the optical detector and the illumination light source in response to the optical detector having a low frame rate or a small detection surface.

8. The optical navigation device of claim 1, wherein the optical element assembly comprises a convergence lens.

9. The optical navigation device of claim 1, wherein a detection surface of the optical detector has a specific section with a maximal length than lengths of other sections, a longitudinal direction of the specific section is parallel to a moving direction between the optical navigation device and the target object.

10. The optical navigation device of claim 1, wherein the optical detector and the illumination light source are respectively disposed on two opposite sides of the optical element assembly.

11. The optical navigation device of claim 1, wherein the optical element assembly and the illumination light source are respectively disposed on two opposite sides of the optical detector.

12. The optical navigation device of claim 1, wherein a specific included angle is formed between an optical detection axis of the optical detector and an optical illumination axis of the illumination light source.

13. The optical navigation device of claim 1, wherein the optical navigation device further comprises a beam splitter, the optical detector and the illumination light source are disposed respectively corresponding to two opposite optical surfaces of the beam splitter.
